(19) United States
(12) Patent Application Publication
(10) Pub. No.: US 2004/0136690 A1
(43) Pub. Date: Jul. 15, 2004

(54) Controlling the recording of a media program

(75) Inventors: Randal Alan Anders, Round Rock, TX (US); Chao M. Beck, Austin, TX (US); Michael Alan Copenhaver, Austin, TX (US); Carol Ann Dolan, Austin, TX (US); William Joel Hoch, Liberty Hill, TX (US); Paul William Podipny, Austin, TX (US); Jeffrey Walter Richardson, Austin, TX (US); David Neal Rundell, Leander, TX (US)

Correspondence Address: Marilyn Smith Dawkins, Intellectual Property Law Dept., IBM Corporation, 11400 Burnet Road, Austin, TX, 78758, US

(73) Assignee: International Business Machines Corporation, Armonk, NY (US)

(21) Appl. No.: 10/339,773

(22) Filed: Jan. 9, 2003

(51) Int. Cl. H04N 5/76; G06F 3/00; G06F 13/00

(52) U.S. Cl. 386/83; 386/125

(57) ABSTRACT

A method, system, and program for controlling the recording of a media program are provided. In response to detecting a match between a selection of program preferences and a particular program from multiple scheduled media programs, a communication with a user at a communication device is initiated to notify the user about the particular program. In response to receiving a request to record the particular program from the communication device, a recording of the particular program is controlled, such that at a location remote from a media program display device the user is enabled to initiate recording of programs likely of interest to the user. The multiple scheduled media programs may include, for example, television broadcast programs and internet broadcast video.

### BACKGROUND OF THE INVENTION

1. Technical Field

The present invention relates in general to media broadcast systems and, in particular, to recording media programs. Still more particularly, the present invention relates to triggering a phone call to a user when a preferred media program is available, such that the user is enabled via a remote location to designate whether to record the preferred media program.

2. Description of the Related Art

The types and sources of media available to consumers continue to expand. Consumers can watch a myriad of television broadcast programs available from cable and satellite providers. Further, consumers can watch and listen to broadcast video and audio streams via the internet.

With so many sources of media available, it becomes difficult for consumers to track those programs that may be of interest to the consumer via every media source available to the consumer. Current systems track television program schedules from one cable provider and allow users to designate specific shows of interest, such that a user can be notified on a television display when one of these specific shows is playing or a set top box controller will automatically record these specific shows. These current tracking systems are limited. It would be advantageous for a user not only to set specific show preferences, but preferences for types of events, actors, times and stations. Further, it would be advantageous for the user's preferences to be compared with a program schedule that includes both television and internet-based broadcast programs.

Further, with so many sources of media available, it becomes difficult for consumers to view all programs of interest to the consumer. Recording technology allows consumers to pre-program a time and channel to record. Current recording technology, however, is also limited. It would be advantageous if rather than a user initiating recording programming, if the recording system initiates the recording programming.

### SUMMARY OF THE INVENTION

In view of the foregoing, it is therefore an object of the present invention to provide improved media broadcast systems.

It is another object of the present invention to provide a method, system and program for recording media programs.

It is yet another object of the present invention to provide a method, system and program for triggering a phone call to a user when a preferred media program is available.

According to one aspect of the present invention, in response to detecting a match between a selection of program preferences and a particular program from multiple scheduled media programs, a communication with a user at a communication device is initiated to notify the user about the particular program. In response to receiving a request to record the particular program from the communication device, a recording of the particular program is controlled, such that at a location remote from a media program display device the user is enabled to initiate recording of programs likely of interest to the user. The multiple scheduled media programs may include, for example, television broadcast programs and internet broadcast video.

Initiating a communication with a user at a communication device may be limited to selected times during which the user selects to receive communications. Further, a user may designate a specific communication device to be contacted during one time period and another communication device to be contacted during another time period. Multiple types of communication devices may be accessed. For example, communication devices may include, but are not limited to, a telephony device accessible via the public switching telephone network, a telephony device accessible via a digital network, and an instant messaging controller supported by a computer system accessible via a network.

In addition, the communication with a user at a communication device may be initiated from a set top box controller enabled to receive the particular program. Alternatively, the communication may be initiated from a program provider enabled to transmit the particular program.

In response to detecting a user initiation of recording, the recording of the particular program may be controlled at a data storage system local to a set top controller enabled to receive the particular program. Alternatively, recording of the particular program may be controlled at a data storage system controlled by program provider enabled to transmit the particular program.

All objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 depicts a block diagram of one embodiment of a computer system with which the method, system and program of the present invention may advantageously be utilized

FIG. 2 depicts a block diagram of a program notification system in which a set top box initiates communication and recording, in accordance with the method, system, and program of the present invention;

FIG. 3 depicts a block diagram of a set top box which initiates communication with a user when a preferred program is available, in accordance with the method, system, and program of the present invention;

FIG. 4 depicts a block diagram of a program notification system in which a program provider initiates notification and recording, in accordance with the method, system, and program of the present invention;

FIG. 5 depicts a block diagram of a programming provider which initiates communication with a user when a preferred program is available, in accordance with the method, system, and program of the present invention;

FIG. 6 depicts an illustrative representation of a display interface for a user to select program preferences in accordance with the method, system, and program of the present invention;

FIG. 7 depicts an illustrative representation of a display interface for a user to select communication preferences in accordance with the method, system, and program of the present invention; and

FIG. 8 depicts a high level logic flowchart of a process and program for controlling communication and recording of a selected preferred program, in accordance with the method, system, and program of the present invention.

### DETAILED DESCRIPTION OF THE PREFERRED EMBODIMENT

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

The present invention may be executed in a variety of systems, including a variety of computing systems and electronic devices under a number of different operating systems. In general, the present invention is executed in a computer system that performs computing tasks such as manipulating data in storage that is accessible to the computer system. In addition, the computer system includes at least one output device and at least one input device.

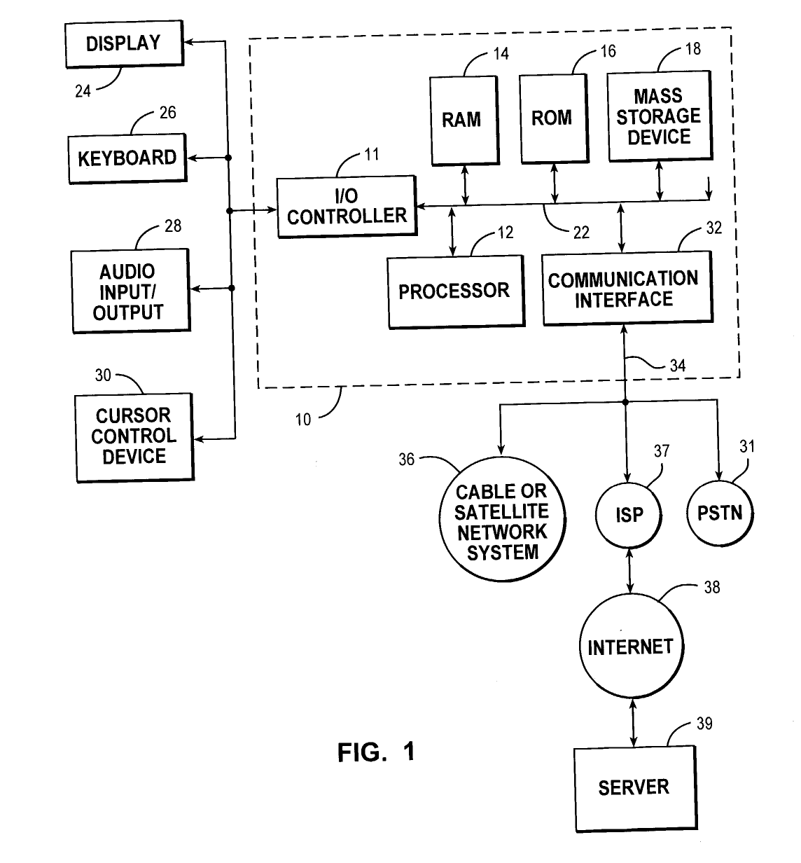

Referring now to the drawings and in particular to FIG. 1, there is depicted one embodiment of a computer system with which the method, system and program of the present invention may advantageously be utilized. Computer system 10 includes a bus 22 or other communication device for communicating information within computer system 10, and at least one processing device such as processor 12, coupled to bus 22 for processing information. Bus 22 preferably includes low-latency and higher latency paths that are connected by bridges and controlled within computer system 10 by multiple bus controllers.

Processor 12 may be a general-purpose processor such as IBM's PowerPC™ processor that, during normal operation, processes data under the control of operating system and application software stored in a dynamic storage device such as random access memory (RAM) 14 and a static storage device such as Read Only Memory (ROM) 16. The operating system preferably provides a graphical user interface (GUI) to the user. In a preferred embodiment, application software contains machine executable instructions that when executed on processor 12 carry out the operations depicted in the flowchart of FIG. 14, and others described herein. Alternatively, the steps of the present invention might be performed by specific hardware components that contain hardwired logic for performing the steps, or by any combination of programmed computer components and custom hardware components.

The present invention may be provided as a computer program product, included on a machine-readable medium having stored thereon the machine executable instructions used to program computer system 10 to perform a process according to the present invention. The term “machine-readable medium” as used herein includes any medium that participates in providing instructions to processor 12 or other components of computer system 10 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM) or any other optical medium, punch cards or any other physical medium with patterns of holes, a programmable ROM (PROM), an erasable PROM (EPROM), electrically EPROM (EEPROM), a flash memory, any other memory chip or cartridge, or any other medium from which computer system 10 can read and which is suitable for storing instructions. In the present embodiment, an example of a non-volatile medium is mass storage device 18. Volatile media include dynamic memory such as RAM 14. Transmission media include coaxial cables, copper wire or fiber optics, including the wires that comprise bus 22. Transmission media can also take the form of acoustic or light waves, such as those generated during radio frequency or infrared data communications.

Moreover, the present invention may be downloaded as a computer program product, wherein the program instructions may be transferred from a remote computer such as a server 39 to requesting computer system 10 by way of data signals embodied in a carrier wave or other propagation medium via a network link 34 (e.g., a modem or network connection) to a communications interface 32 coupled to bus 22. Communications interface 32 provides a two-way data communications coupling to network link 34 that may be connected, for example, to a local area network (LAN), wide area network (WAN), or as depicted herein, directly to an Internet Service Provider (ISP) 37. In particular, network link 34 may provide wired and/or wireless network communications to one or more networks.

ISP 37 in turn provides data communication services through the Internet 38 or other network. Internet 38 may refer to the worldwide collection of networks and gateways that use a particular protocol, such as Transmission Control Protocol (TCP) and Internet Protocol (IP), to communicate with one another. ISP 37 and Internet 38 both use electrical, electromagnetic, or optical signals that carry digital data streams. The signals through the various networks and the signals on network link 34 and through communication interface 32, which carry the digital data to and from computer system 10, are exemplary forms of carrier waves transporting the information.

In addition, communications interface 32 provides two-way data communication coupling to a cable or satellite network system 36 and a public switching telephone network (PSTN) 31 via network link 34. Cable or satellite network system 36 may be implemented with an incoming cable line (e.g. on a coax cable), satellite broadcasts, or any other medium capable of transmitting a signal.

Further, multiple peripheral components may be added to computer system 10, connected to an input/output (I/O) controller 11 coupled to bus 22. For example, an audio input/output device 28 is attached to I/O controller 11 for controlling audio input through a microphone or other sound or lip motion capturing device and for controlling audio output through a speaker or other audio projection device. A display 24 is also attached to I/O controller 11 for providing visual, tactile or other graphical representation formats. A keyboard 26 and cursor control device 30, such as a mouse, trackball, or cursor direction keys, are coupled to I/O controller 11 as interfaces for user inputs to computer system 10. In alternate embodiments of the present invention, additional input and output peripheral components may be added.

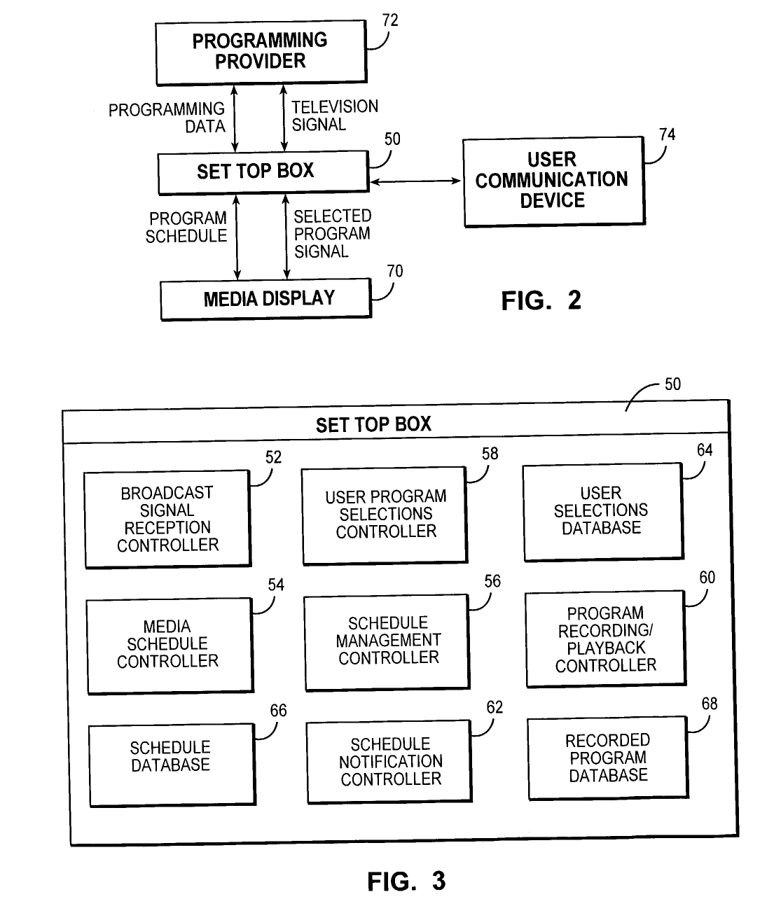

Referring now to FIG. 2, there is depicted a block diagram of a program notification system in which a set top box initiates communication and recording, in accordance with the method, system, and program of the present invention. As illustrated, a set top box 50 controls output of a selected program signal and a program schedule to television display 70. Set top box 50 at its most basic function is a tuner for switching media display 70 to a particular channel. Advantageously, set top box 50 may also include the functionality of a computer system, such as computer system 10 of FIG. 1, specified to perform certain functions of the present invention. It will be understood that while a single media display 70 is depicted in the example, set top box 50 may control multiple media displays.

Set top box 50 is enabled to receive a channel selection from inputs to devices including, but not limited to, a remote control unit, a personal digital assistant, and an input interface on set top box 50 itself. Further, set top box 50 is enabled to receive a channel selection, which may be in the form of a specific program selection, from user communication device 74. Further, rather than selecting a standard channel, a user may enter a web address to access an internet broadcast where programming provider 72 provides both television broadcast programs and internet broadcast programs.

Programming provider 72 provides programming schedule data and a program signal via cable, satellite broadcast, internet, or other signal mediums. Set top box 50 controls output of a selected program signal to media display 70 according to a channel selection. In addition, set top box 50 controls output of a program schedule display on media display 70. A user may interact with the schedule display to select a channel for current viewing or select a program to record. In addition, according to the present invention, the program schedule display allows a user to select program and communication preferences, such that the user can be contacted at a particular communication device if a preferred show is going to air.

Set top box 50 includes a network link for communicating via a network to a user communication device 74 to notify a user of a preferred program. User communication device 74 may include multiple types of telephony devices including, but not limited to, a land-line phone, a wireless telephone device, a personal computer system, and a pager. The network utilized to access user communication device 74 may include, for example, the PSTN or the Internet. Further, it will be understood that in the present invention, set top box 50 may communicate with a server via the network link, where the server then formats and controls communications with user communication device 74 through the appropriate type of network.

With reference now to FIG. 3, there is depicted a block diagram of a set top box which initiates communication with a user when a preferred program is available, in accordance with the method, system, and program of the present invention. As illustrated, in addition to processing components illustrated in FIG. 1, set top box 50 includes multiple controllers and databases. First, a broadcast signal reception controller 52 manages the television signal received from the programming provider and tunes the television signal to a selected channel. Next, media schedule controller 54 manages the programming schedule data received from the programming provider and stores the scheduling data in schedule database 66. In addition, media schedule controller 54 controls the display of the schedule on the television display. Advantageously, the schedule may include both television and interest-based broadcast programs.

A user program selections controller 58 supports displaying a menu for a user to select program and communication preferences, and receiving and storing the user selections in user selections database 64. A schedule management controller 56 compares the program preferences in user selections database 64 with the current schedule in schedule database 66. If schedule management controller 56 detects a match between a program preference and the current schedule, then schedule management controller 56 determines whether the user is already watching the television and whether the user has previously recorded the matching program. User selections database 64 preferably includes a record of the programs already recorded by the user. If the user is not watching the television or has not previously recorded the matching program, then schedule management controller 56 prompts schedule notification controller 62 to contact the user with the preferred program. It will be understood that multiple programs in the current schedule may match the user's program preferences. Further, it will be understood that set top box 50 may track program preferences for multiple users. Further, it will be understood that set top box 50 may track the users currently watching television by requiring users to input an identification such as a voice sample or by photometric detection of users.

Upon receiving a prompt to contact a user, schedule notification controller 62 determines which communication device should be contacted and when the user should be contacted. A user may select time periods during which no contacts should be initiated. Schedule notification controller 62 may contact the user by multiple methods including, but not limited to, sending a text message with the preferred program information, dialing a number and provide voice synthesized preferred program information, initiating an instant message with the preferred program information, or sending the preferred program information in an alternate format to an alternate communication device. It will be understood that a portion of the functions performed by set top box 50 may be distributed to a remote server system accessible via a network. For example, schedule notification controller 62 may determine when a user should be contacted and send that request to a remote server enabled to determine where to contact the user. In addition, the remote server would format the communication depending on the type of user communication device.

In response to receiving a contact indicating the preferred program information, a user may select, via the communication device, to record a preferred program. Schedule notification controller 62 detects and sends the requests to program recording/playback controller 60. Program recording/playback controller 60 initiates recording the requested program to a recorded program database 68. Later, program recording/playback controller 60 controls play of the recorded program from recorded program database on the television display. It should be noted that program recording/playback controller 60 may record a preferred program selected by one user while another program is displayed on television display 70.

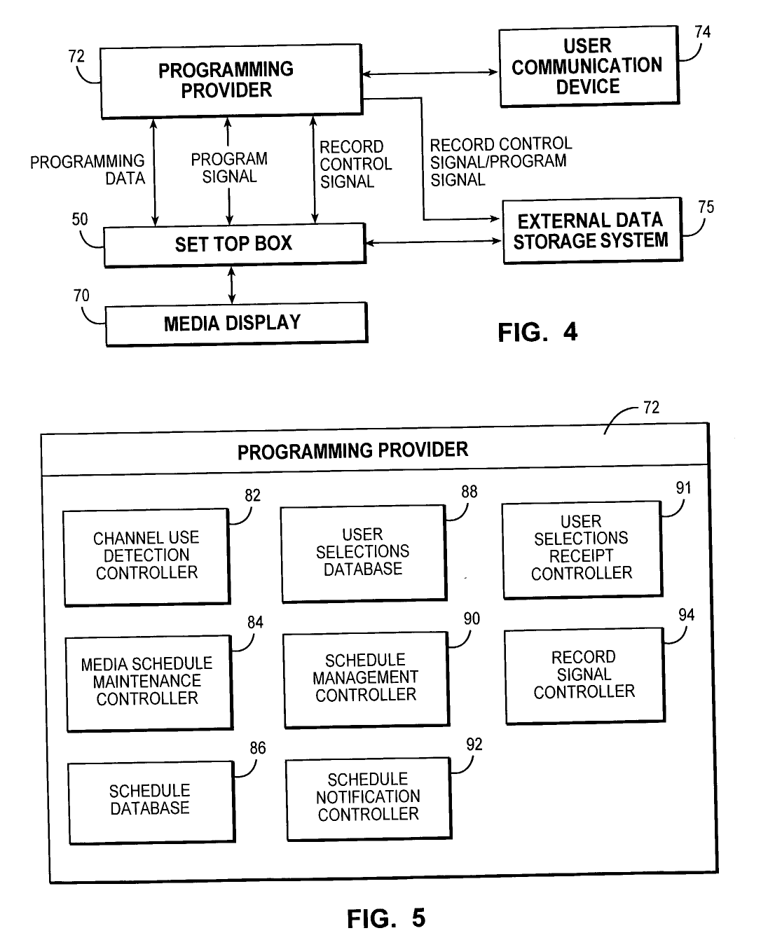

Referring now to FIG. 4, there is depicted a block diagram of a program notification system in which a program provider initiates notification and recording, in accordance with the method, system, and program of the present invention. The system described in FIG. 4 is similar to the system described in FIG. 2, except in the system described in FIG. 4, programming provider 72 initiates communication with a user to notify the user a preferred program is available and triggers a record signal to set top box 50 if the user requests to record a preferred program. Advantageously, programming provider 72 may also include the functionality of a computer system, such as computer system 10 of FIG. 1, specified to perform certain functions. It will be understood that programming provider 72 interacts with multiple set top boxes.

Programming provider 72 provides programming schedule data and a television signal via cable, satellite broadcast, internet, or other signal mediums. Set top box 50 controls output of a selected program signal to media display 70 according to a channel selection. In addition, set top box 50 controls output of a program schedule display on media display 70. A user may interact with the schedule display to select a channel for current viewing or select a program to record. In addition, according to the present invention, the program schedule display allows a user to select program and communication preferences, such that the user can be contacted at a particular communication device if a preferred program is going to air. The user selections are transmitted from set top box 50 to programming provider 72 for storage in association with the user's account.

If a user chooses to record a preferred program, programming provider 72 may transmit a record signal to set top box 50 to record the preferred program locally. Alternatively, programming provider 72 may transmit a record signal and program signal to an external data storage system to record the preferred program. Set top box 50 may later access external data storage system 75 via a network to retrieve the stored program and play the program on television display 70.

Programming provider 72 also includes a network link for communicating via a network to a user communication device 74. User communication device 74 may include multiple types of telephony devices including, but not limited to, a land-line phone, a wireless telephone device, a personal computer system, and a pager. The network utilized to access user communication device 74 may include, for example, the PSTN or the Internet. Further, it will be understood that programming provider 72 may communicate with a remote server via the network link, where a server then formats and controls communications with user communication device 74 through the appropriate type of network.

With reference now to FIG. 5, there is illustrated a block diagram of a programming provider which initiates communication with a user when a preferred program is available, in accordance with the method, system, and program of the present invention. As illustrated, in addition to processing components illustrated in FIG. 1, programming provider 72 includes multiple controllers and databases. First, programming provider 72 includes a channel use detection controller 82 to detect which channel is currently selected at set top box 50 and may also detect which users are watching the current program. Next, a media schedule maintenance controller 84 controls updating the program schedule in schedule database 86 and transferring the program schedule to set top box 50.

A user selections receipt controller 91 supports receiving user selections of program and communication preferences from set top box 50 and storing those selections in user selections database 88. User selections database 88 stores selections for multiple users.

A schedule management controller 90 compares the program preferences in user selections database 88 with the current schedule in schedule database 86. If schedule management controller 90 detects a match between a program preference and the current schedule, then schedule management controller 90 determines whether the user is already watching the television through channel use detection controller 82 and whether the user has previously recorded the matching program. User selections database 88 may store a record of previously recorded programs by user.

If the user is not watching the television or has not previously recorded the matching program, then schedule management controller 90 prompts schedule notification controller 92 to contact the user with the preferred program. It will be understood that multiple programs in the current schedule may match the user's program selections. Further, it will be understood that programming provider 72 may track program preferences for multiple users of a single set top box 50.

Upon receiving a prompt to contact a user, schedule notification controller 92 determines which communication device should be contacted and when the user should be contacted. A user may select time periods during which no contacts should be initiated. Schedule notification controller 92 may contact the user by multiple methods including, but not limited to, sending a text message with the preferred program information, dialing a number and provide voice synthesized preferred program information, initiating an instant message with the preferred program information, or sending the preferred program information in an alternate format to an alternate communication device. It will be understood that a portion of the functions performed by programming provider 72 may be distributed to a remote server system accessible via a network. For example, schedule notification controller 92 may determine when a user should be contacted and send that request to a remote server enabled to determine where to contact the user. In addition, the remote server would format the communication depending on the type of user communication device.

In response to receiving a contact indicating the preferred program information, a user may select, via the communication device, to record a preferred program. Schedule notification controller 92 detects and sends the requests to record signal controller 94. Record signal controller 94 transmits a record signal to set top box 50 to initiate recording the preferred program to a data storage system local to set top box 50. Alternatively, record signal controller may initiate recording the preferred program to a remote data storage system accessible to set top box 50 via a network.

Controlling notification of a user from programming provider 72 has an advantage that programming provider 72 may detect the user viewing a television at any of the set top boxes to which programming provider 72 supplies a program signal. Then, if programming provider 72 prompts the user at any of the set top boxes to which programming provider 72 provides a program signal, the user may select to record a preferred program at a “home” set top box or a remote data storage location.

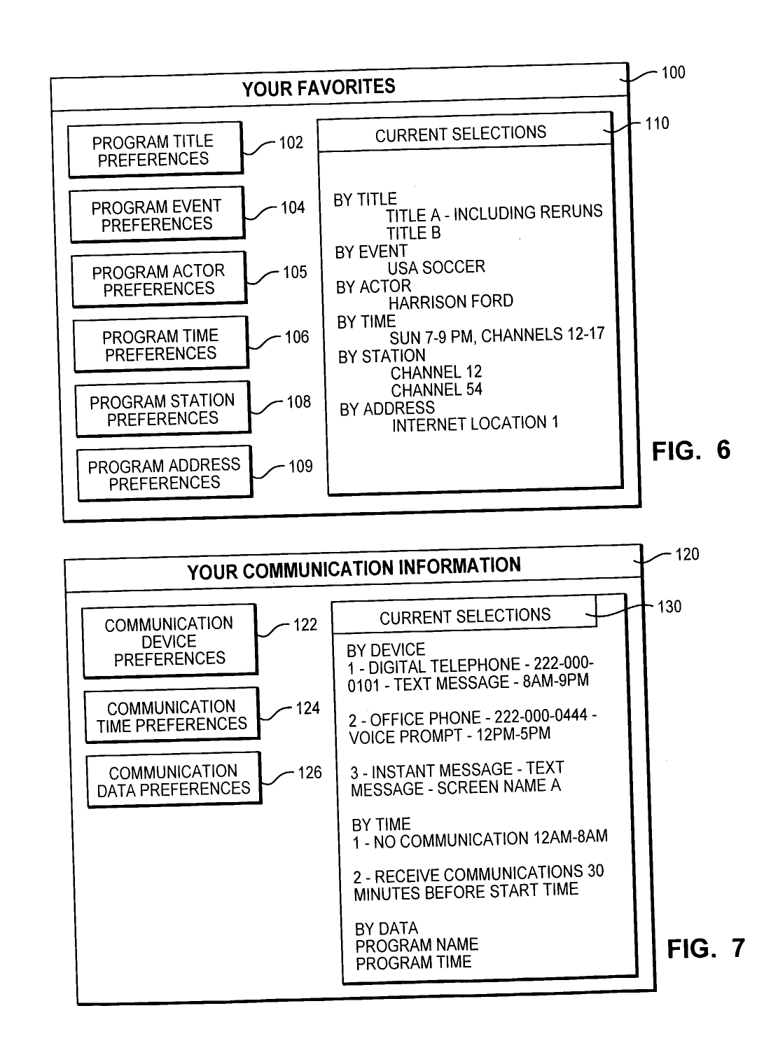

Referring now to FIG. 6, there is an illustrative representation of a display interface for a user to select program preferences in accordance with the method, system, and program of the present invention. As depicted, a window 100 includes multiple selectable entries 102, 104, 105, 106, 108, and 109. A user may select one of the selectable entries through the input interface supported by the set top box, such as by cursor control or scrolling. In response to selection of one of the selectable entries, the user is prompted to designate specific preferences. For example, if a user selects program title preferences entry 102, the user is prompted to select titles from a list of available titles or enter the title of a program of interest. In the example, a user may specify title, event, actor, time, station, and address preferences. It will be understood that in alternate embodiments, the user may select from other types of preferences, such as program ratings.

In addition, window 100 includes a current selections window 110 for displaying a user's current program preferences. The set top box or the programming provider compare the user's program preferences with the program schedule to select currently showing preferred programs for the user. A show need not meet all the parameters selected by a user, however shows that meet more than one parameter might be indicated as such a symbol or other rating system.

In the example, the user selected two program titles preferences. In particular, the user indicated a preference for new shows and reruns of title A, but only new shows of title B. Further, the user indicated a preference for a type of event that may be placed under different titles. The program schedule preferably indicates at least the main actors in a program, such that programs can be selected for the user according to the user's preference in actors. A user may indicate a time block during which the user would like to receive notification of the programs available on certain channels, or all channels. Further, the user may specify a preference to be contacted about every program available on a particular channel. Additionally, a user may specify particular web addresses that broadcast video or audio.

With reference now to FIG. 7, there is an illustrative representation of a display interface for a user to select communication preferences in accordance with the method, system, and program of the present invention. As illustrated, a window 120 includes multiple selectable entries 122, 124, and 126. A user may select one of the selectable entries through an input interface supported by the set top box. In response to selection of one of the selectable entries, the user is prompted to designate specific preferences. For example, if a user selects communication device preferences 122, the user is prompted to select a type of device, the contact information for the device, the preferred information format and times during which the device should be accessed. In addition to indicating a telephone, a user may request an instant message or other method of instantaneous communication.

In addition, window 120 includes a current selections window 130 for displaying a user's current communication preferences. The set top box or the programming provider filter through the user's communication preferences to select the appropriate communication device to contact, if one is to be contacted. As illustrated in the example, a user may select communication preferences by device, time, data. In alternate embodiments, other types of preferences may be selected by a user.

In the example, the user specified three types of communication devices and parameters for contact via each of the communication devices. In addition, the user specified a time period during which not to receive communications. Preferably, a user may also specify when the user would like to receive communications about a program. In this example, the user specified communications should occur thirty minutes before the preferred program is scheduled to start. Further, the user specified the type of data to be sent: the program name and the program time.

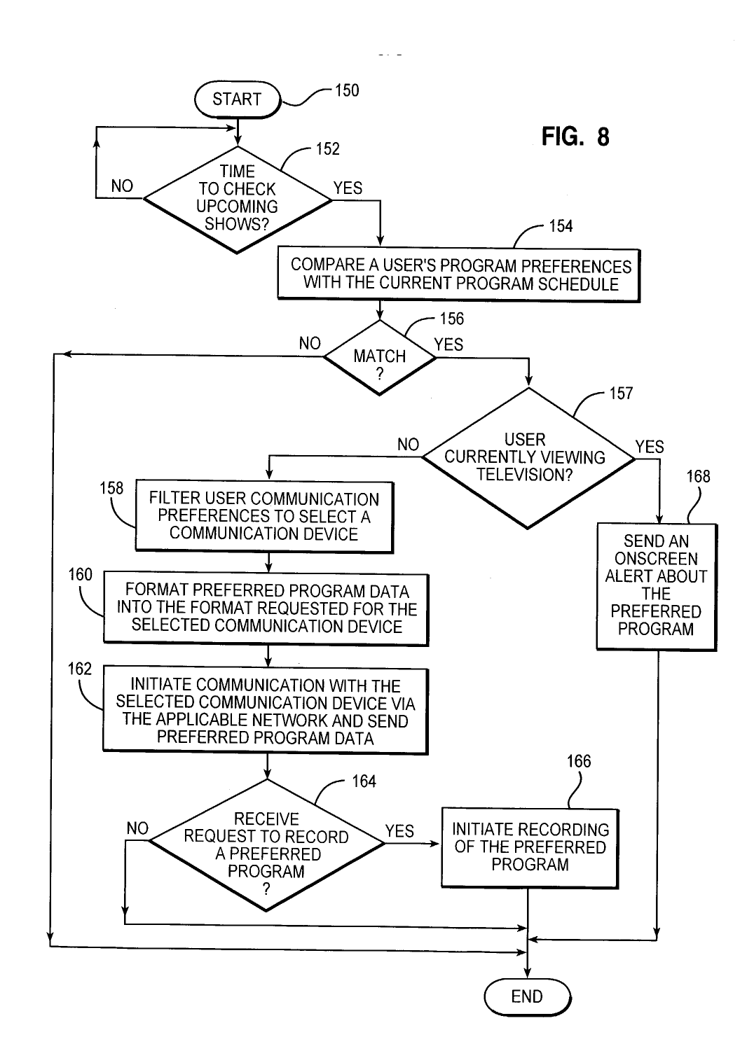

Referring now to FIG. 8, there is depicted a high level logic flowchart of a process and program for controlling communication and recording of a selected preferred program, in accordance with the method, system, and program of the present invention. As illustrated, the process starts at block 150 and thereafter proceeds to block 152. Block 152 depicts a determination whether it is time to check upcoming shows. If it is time to check for upcoming shows, then the process passes to block 154; otherwise, the process iterates at block 152. Each user may indicate a preference controlling when to receive communications about preferred programs. Block 154 depicts comparing a user's program preferences with the current program schedule. Next, block 156 illustrates a determination whether there is a match between the user's program preferences and the current program schedule. If there is not a match, then the process ends. If there is a match, then the process passes to block 157. Where a preferred program matches multiple program preferences, information indicating the proximity of a total match may be attached to the preferred program data. A user may further set a preference to only receive communications about preferred program with a proximity to a total match above a selected percentage.

Block 157 illustrates a determination whether the user is currently viewing the television. If the user is not currently viewing the television, then the process passes to block 158. However, if the user is currently viewing the television, then the process passes to block 168. Block 168 depicts sending an onscreen alert about the preferred program, and the process ends.

Block 158 depicts filtering the user communication preferences to select a communication device. Next, block 160 illustrates formatting the preferred program data into the format requested for the selected communication device, which may include text and voice communications. Thereafter block 162 depicts initiating communication with the selected communication device via the applicable network and sending the preferred program data. If the attempted communication with the selected communication device fails, then the process may select an alternate communication device and attempt communication.

Next, block 164 illustrates a determination whether a request to record the preferred program is received. If a request to record the preferred program is not received, then the process ends. If a request to record the preferred program is received, then the process passes to block 166. Block 166 depicts initiating a recording of the preferred program, and the process ends. Where the set top box is performing this process, then the set top box may initiate a recording to a local data storage system. Where the programming provider is performing this process, then the programming provider may transmit a record signal to the set top box to initiate a recording to a local data storage system, or may record the preferred program to a remote data storage location accessible by the set top box for later play.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular types of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

While the invention has been particularly shown and described with reference to a preferred embodiment, it will be understood by those skilled in the art that various changes in form and detail may be made therein without departing from the spirit and scope of the invention.

What is claimed is:

1. A method for controlling a recording of a media program, comprising:
in response to detecting a match between a selection of a plurality of program preferences and a particular program from among a plurality of scheduled media programs, initiating a communication with a user at a communication device remote from a program display to notify said user about said particular program through said communication device; and
in response to receiving a request to record said particular program through said communication device, controlling a recording of said particular program.

2. The method for controlling a recording according to claim 1, wherein initiating said communication with said user further comprises:
only initiating said communication with said user when a current time matches a time selected by said user to receive communications through said communication device.

3. The method for controlling a recording according to claim 1, wherein initiating said communication with said user further comprises:
initiating said communication with said user at said communication device from a set top box controller enabled to receive said particular program.

4. The method for controlling a recording according to claim 1, wherein initiating said communication with said user further comprises:
initiating said communication with said user at said communication device from a programming provider enabled to transmit said particular program.

5. The method for controlling a recording according to claim 1, further comprising:
in response to detecting said initiation of a recording, controlling said recording of said particular program at a data storage system local to a set top controller enabled to receive said particular program.

6. The method for controlling a recording according to claim 1, further comprising:
in response to detecting said initiation of a recording, controlling said recording of said particular program at a data storage system accessible via a network to a set top controller enabled to retrieve and broadcast said particular program from said data storage system.

7. A system for controlling a recording of a media program, comprising:
means, responsive to detecting a match between a selection of a plurality of program preferences and a particular program from among a plurality of scheduled media programs, for initiating a communication with a user at a communication device remote from a program display to notify said user about said particular program through said communication device; and
means, responsive to receiving a request to record said particular program through said communication device, for controlling a recording of said particular program.

8. The system for controlling a recording according to claim 7, wherein said means for initiating said communication with said user further comprises:
means for only initiating said communication with said user when a current time matches a time selected by said user to receive communications through said communication device.

9. The system for controlling a recording according to claim 7, wherein said means for initiating said communication with said user further comprises:
means for initiating said communication with said user at said communication device from a set top box controller enabled to receive said particular program.

10. The system for controlling a recording according to claim 7, wherein said means for initiating said communication with said user further comprises:
means for initiating said communication with said user at said communication device from a programming provider enabled to transmit said particular program.

11. The system for controlling a recording according to claim 7, further comprising:
means, responsive to detecting said initiation of a recording, for controlling said recording of said particular program at a data storage system local to a set top controller enabled to receive said particular program.

12. The system for controlling a recording according to claim 7, further comprising:
means, responsive to detecting said initiation of a recording, for controlling said recording of said particular program at a data storage system accessible via a network to a set top controller enabled to retrieve and broadcast said particular program from said data storage system.

13. The system for controlling a recording according to claim 7, wherein said communication device is at least one from among a telephony device accessible via the public switching telephone network, a telephony device accessible via a digital network, and an instant messaging controller supported by a computer system accessible via a network.

14. The system for controlling a recording according to claim 7, wherein said plurality of scheduled media programs comprises at least one from among a television broadcast program and an internet broadcast program.

15. A computer program product for controlling a recording of a media program, comprising:
a recording medium;
means, recorded on said recording medium, for initiating a communication with a user at a communication device remote from a program display to notify said user about said particular program through said communication device, responsive to detecting a match between a selection of a plurality of program preferences and a particular program from among a plurality of scheduled media programs;
means, recorded on said recording medium, for controlling a recording of said particular program, responsive to receiving a request to record said particular program through said communication device.

16. The computer program product for controlling a recording according to claim 15, wherein said means for initiating said communication with said user further comprises:
means, recorded on said recording medium, for only initiating said communication with said user when a current time matches a time selected by said user to receive communications through said communication device.

17. The computer program product for controlling a recording according to claim 15, wherein said means for initiating said communication with said user further comprises:
means, recorded on said recording medium, for initiating said communication with said user at said communication device from a set top box controller enabled to receive said particular program.

18. The computer program product for controlling a recording according to claim 15, wherein said means for initiating said communication with said user further comprises:
means, recorded on said recording medium, for initiating said communication with said user at said communication device from a programming provider enabled to transmit said particular program.

19. The computer program product for controlling a recording according to claim 15, further comprising:
means, recorded on said recording medium, for controlling said recording of said particular program at a data storage system local to a set top controller enabled to receive said particular program, responsive to detecting said initiation of a recording.

20. The computer program product for controlling a recording according to claim 15, further comprising:
means, recorded on said recording medium, for controlling said recording of said particular program at a data storage system accessible via a network to a set top controller enabled to retrieve and broadcast said particular program from said data storage system, responsive to detecting said initiation of a recording.
